(19) United States
(12) Patent Application Publication
(10) Pub. No.: US 2025/0174886 A1
(43) Pub. Date: May 29, 2025

(54) ANTENNA AND COMMUNICATION DEVICE

(71) Applicant: HUAWEI TECHNOLOGIES CO., LTD., Shenzhen (CN)

(72) Inventors: Chengdai XUE, Dongguan (CN); Zhiwei ZHOU, Shenzhen (CN); Tianzhu SHENG, Dongguan (CN); Dingjiu DAOJIAN, Dongguan (CN); Zhuofeng CHEN, Shenzhen (CN)

(21) Appl. No.: 19/039,191

(22) Filed: Jan. 28, 2025

Related U.S. Application Data
(63) Continuation of application No. PCT/CN2023/094573, filed on May 16, 2023.

(30) Foreign Application Priority Data
Jul. 29, 2022 (CN) 202210905341.8

(51) Int. Cl. H01Q 1/52; H01Q 5/20; H01Q 5/35

(52) U.S. Cl. CPC H01Q 1/526; H01Q 5/20; H01Q 5/35

(57) ABSTRACT

Example communication apparatus and methods are described. One example communication apparatus includes an antenna that includes a first radiation assembly, a second radiation assembly, and a feeder assembly. An operating frequency of the second radiation assembly is less than an operating frequency of the first radiation assembly, and the feeder assembly is in feeding connection to the first radiation assembly. The feeder assembly includes a first feeder, a ground cable, and a second feeder that are stacked sequentially, and the feeder assembly has a length ranging from one-eighth to one-half of an operating wavelength of the second radiation assembly.

### CROSS-REFERENCE TO RELATED APPLICATIONS

This application is a continuation of International Application No. PCT/CN2023/094573, filed on May 16, 2023, which claims priority to Chinese Patent Application No. 202210905341.8, filed on Jul. 29, 2022. The disclosures of the aforementioned applications are hereby incorporated by reference in their entireties.

### TECHNICAL FIELD

This application relates to the field of communication technologies, and in particular, to an antenna and a communication device.

### BACKGROUND

With continuous development of communication technologies, people have higher requirements on performance of communication devices. For example, in a wireless communication device, an antenna is usually used to implement a radio signal transmission function. In the background of a massive multiple-input multiple-output technology, a large quantity of radiation assemblies needs to be arranged in an antenna. When a distance between the radiation assemblies is small, electromagnetic coupling between two adjacent radiation assemblies is inevitably caused. Electromagnetic coupling between radiation assemblies not only increases a power loss of the antenna, but also causes a bad case such as signal distortion. Therefore, reducing the electromagnetic coupling between the radiation assemblies is crucial to design of a massive array antenna.

### SUMMARY

This application provides an antenna and a communication device that are simple in structure and can effectively reduce electromagnetic coupling between radiation assemblies.

According to a first aspect, this application provides an antenna, including a first radiation assembly, a second radiation assembly, and a feeder assembly, where an operating frequency of the second radiation assembly is less than an operating frequency of the first radiation assembly; and the feeder assembly is in feeding connection to the first radiation assembly. The feeder assembly includes a first feeder, a ground cable, and a second feeder that are stacked sequentially, and a length of the feeder assembly is one-eighth to one-half of an operating wavelength of the second radiation assembly. In the antenna provided in this application, a length of a feeder assembly of a radiation assembly operating in a relatively high frequency band (for example, the first radiation assembly) is properly set, so that electromagnetic coupling between the first radiation assembly and the second radiation assembly can be effectively reduced.

In an example, the ground cable may have an open-circuit stub, a length of the open-circuit stub may be one-quarter of an operating wavelength of the first radiation assembly, and the open-circuit stub may be configured to suppress radiation of the ground cable.

In an example, the antenna may further include a shielding part, and the shielding part may be disposed on a periphery of the feeder assembly, and is configured to suppress signal radiation of the feeder assembly.

For example, the feeder assembly may have a corner, and the shielding part may be disposed close to the corner.

During specific setting, the shielding part may be U-shaped. The shielding part is sleeved on the periphery of the feeder assembly, and two ends of the shielding part are grounded.

Alternatively, in an example, the antenna may include a backplane, and one end that is of the feeder assembly and that is away from the first radiation assembly is connected to the backplane.

In an example, an avoidance groove is provided at one end that is of the ground cable and that is away from the first radiation assembly, and projections of the first feeder and the second feeder on the ground cable are located in the avoidance groove, to avoid position interference between the ground cable and the first feeder and between the ground cable and the second feeder.

During disposition of the first radiation assembly, the first radiation assembly may include a first polarization strip, a second polarization strip, and a feeder assembly. The first radiation assembly includes a substrate, and the substrate has a first plate surface and a second plate surface that are disposed facing away from each other. A conductive layer is disposed on the first plate surface, and the conductive layer is provided with a first polarization radiation slot and a second polarization radiation slot. The first polarization radiation slot and the second polarization radiation slot may be excited to generate radio signals; or the first polarization radiation slot and the second polarization radiation slot may effectively receive external radio signals. Specifically, the first polarization radiation slot includes a first slot segment and a second slot segment that are separated from each other, and the second polarization radiation slot includes a third slot segment and a fourth slot segment that are separated from each other. The first polarization strip is configured to excite the first slot segment and the second slot segment of the first polarization radiation slot. The second polarization strip is configured to excite the third slot segment and the fourth slot segment in the second polarization radiation slot. The feeder assembly includes a first feeder, a ground cable, and a second feeder. The first feeder is connected to the first polarization strip, the second feeder is connected to the second polarization strip, and the ground cable is connected to the conductive layer.

The first polarization strip may be simultaneously for exciting the first slot segment and the second slot segment, so that a balanced feeding function can be implemented. The second polarization strip may be simultaneously for exciting the third slot segment and the fourth slot segment, so that a balanced feeding function can be implemented. Therefore, the first polarization strip and the second polarization strip may be used as balun structures. In addition, because the first polarization strip and the second polarization strip are integrated on the substrate, it is beneficial to implementation of a flat design of the antenna. During manufacturing of the substrate, the first polarization radiation slot, the second polarization radiation slot, the first polarization strip, and the second polarization strip may also be manufactured. Therefore, convenience during manufacturing is improved.

In an example, the feeder assembly may be of a sandwich-shaped structure. For example, the first feeder, the ground cable, and the second feeder may be stacked sequentially, so that a flat design of the feeder assembly can be implemented. The ground cable may be used as a common ground of the first feeder and the second feeder, and the ground cable can further effectively isolate the first feeder from the second feeder.

In an example, the first polarization strip may have a first connection point, a first feed point, and a second feed point. The first feeder is connected to the first connection point. The first feed point is configured to excite the first slot segment. The second feed point is configured to excite the second slot segment. A signal may be separately transmitted from the first connection point of the first polarization strip to the first feed point and the second feed point. In other words, the first polarization strip may implement a one-to-two signal transmission function.

During specific implementation, a connection distance between the first connection point and the first feed point and a connection distance between the first connection point and the second feed point may be properly set based on an actual requirement, so that balanced feeding can be implemented on the first polarization radiation slot.

For example, the connection distance between the first connection point and the first feed point is equal to the connection distance between the first connection point and the second feed point.

In an example, a first pad may be disposed on the first plate surface of the substrate, and one end of the first feeder is soldered to the first pad. The antenna is provided with a first via that penetrates through the first plate surface and the second plate surface, and the first pad is connected to the first connection point via the first via.

During disposition of the second polarization strip, the second polarization strip may be the same as or approximately the same as the first polarization strip.

For example, in an example, the second polarization strip may have a second connection point, a third feed point, and a fourth feed point. The second feeder is connected to the second connection point. The third feed point is configured to excite the third slot segment. The fourth feed point is configured to excite the fourth slot segment. A signal may be separately transmitted from the second connection point of the second polarization strip to the third feed point and the fourth feed point. In other words, the second polarization strip may implement a one-to-two signal transmission function.

During specific implementation, a connection distance between the second connection point and the third feed point and a connection distance between the second connection point and the fourth feed point may be properly set based on an actual requirement, so that balanced feeding can be implemented on the second polarization radiation slot.

For example, the connection distance between the second connection point and the third feed point is equal to the connection distance between the second connection point and the fourth feed point.

In an example, a second pad may be disposed on the first plate surface of the substrate, and one end of the second feeder is soldered to the second pad. The antenna is provided with a second via that penetrates through the first plate surface and the second plate surface, and the second pad is connected to the second connection point through the second via.

In an example, the conductive layer may be further provided with a plurality of isolation grooves, and the plurality of isolation grooves are provided along an edge of the conductive layer, to improve isolation between the first polarization radiation slot and the second polarization radiation slot.

During specific setting, a length of the isolation groove may be one-quarter of the operating wavelength of the first radiation assembly.

Alternatively, in an example, the antenna may include a backplane, and one end that is of the feeder assembly and that is away from the first radiation assembly is connected to the backplane.

In an example, the antenna further includes at least one director. The at least one director is disposed on a side that the first plate surface faces, and is configured to expand an operating bandwidth of the first radiation assembly.

According to a second aspect, this application further provides a communication device, where the communication device may include a controller and any one of the foregoing antennas. The controller may be connected to a feeder assembly, and is configured to perform processing such as frequency selection on a radio frequency signal.

During specific application, the communication device may be a base station, a radar, or the like. A type of the communication device is not limited in this application.

### BRIEF DESCRIPTION OF DRAWINGS

FIG. 1 is a diagram of an application scenario of an antenna system according to an embodiment of this application;

FIG. 2 is a diagram of a structure of a base station antenna feeder system according to an embodiment of this application;

FIG. 3 is a diagram of composition of an antenna system according to an embodiment of this application;

FIG. 4 is a diagram of a three-dimensional structure of an antenna according to an embodiment of this application;

FIG. 5 is a diagram of a three-dimensional structure of a partial structure of an antenna according to an embodiment of this application;

FIG. 6 is a diagram of a three-dimensional structure of a partial structure of an antenna from another perspective according to an embodiment of this application;

FIG. 7 is a diagram of an exploded structure of a partial structure of an antenna according to an embodiment of this application;

FIG. 8 is a diagram of a perspective structure of a partial structure of an antenna according to an embodiment of this application;

FIG. 9 is a diagram of a cross-sectional structure of displaying a bridge structure according to an embodiment of this application;

FIG. 10 is a diagram of a three-dimensional structure of a partial structure of another antenna according to an embodiment of this application;

FIG. 11 is a diagram of a partial structure of another antenna according to an embodiment of this application;

FIG. 12 is a data diagram in which a polarization radiation gain of a second radiation assembly varies with a frequency according to an embodiment of this application;

FIG. 13 is a data diagram in which another polarization radiation gain of a second radiation assembly varies with a frequency according to an embodiment of this application;

FIG. 14 is a directivity pattern of a second radiation assembly according to an embodiment of this application;

FIG. 15 is another directivity pattern of a second radiation assembly according to an embodiment of this application; and

FIG. 16 is another directivity pattern of a second radiation assembly according to an embodiment of this application.

### DESCRIPTION OF EMBODIMENTS

To make the objectives, technical solutions, and advantages of this application clearer, the following further describes this application in detail with reference to the accompanying drawings.

To facilitate understanding of an antenna and a communication device provided in embodiments of this application, the following first describes application scenarios of the antenna and the communication device.

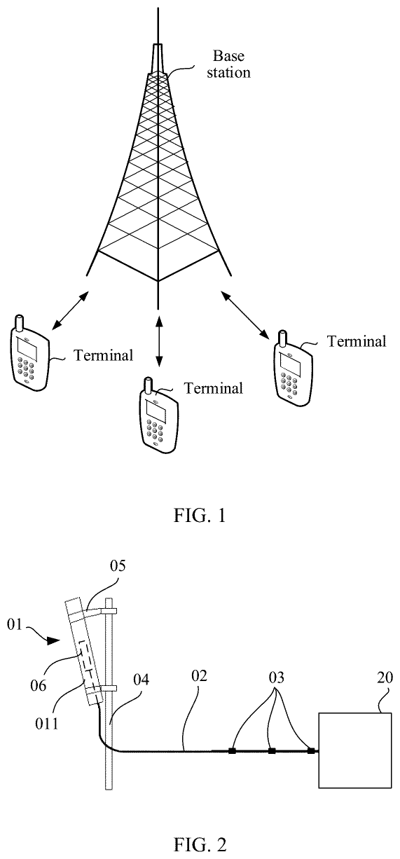

As shown in FIG. 1, an application scenario may include a base station and a terminal. Wireless communication may be implemented between the base station and the terminal. The base station may be located in a base station subsystem (BBS), a terrestrial radio access network (UTRAN), or an evolved universal terrestrial radio access network (E-UTRAN), and is configured to perform cell coverage of a radio signal, to implement communication between a terminal device and a wireless network. Specifically, the base station may be a base transceiver station (BTS) in a global system for mobile communications (GSM) or a code division multiple access (CDMA) system, may be a NodeB (NodeB, NB) in a wideband code division multiple access (WCDMA) system, may be an evolved NodeB (evolved NodeB, eNB, or eNodeB) in a long term evolution (LTE) system, or may be a radio controller in a cloud radio access network (CRAN) scenario. Alternatively, the base station may be a relay station, an access point, a vehicle-mounted device, a wearable device, a g node (gNodeB or gNB) in a new radio (NR) system, a base station in a future evolved network, or the like. This is not limited in embodiments of this application.

As shown in FIG. 2, a base station provided in embodiments of this application includes a base station antenna feeder system. In actual application, the base station antenna feeder system mainly includes an antenna 01, a feeder 02, a grounding apparatus 03, and the like. The antenna 01 is generally fastened on a pole 04, and a downtilt of the antenna 01 may be adjusted through an antenna adjustment mounting bracket 05, to adjust a signal coverage area of the antenna 01 to some extent.

In addition, the base station may further include a radio frequency processing unit 06 (or a controller) and a baseband processing unit 20. For example, the radio frequency processing unit 06 may be configured to: perform frequency selection, amplification, and down-conversion processing on a signal received by the antenna 01, convert the signal into an intermediate frequency signal or a baseband signal, and send the intermediate frequency signal or the baseband signal to the baseband processing unit 20. Alternatively, the radio frequency processing unit 06 is configured to: perform up-conversion and amplification processing on an intermediate frequency signal sent by the baseband processing unit 20, convert the intermediate frequency signal into a radio signal through the antenna 01, and send the radio signal. The baseband processing unit 20 may be connected to a feeding network of the antenna 01 through the radio frequency processing unit 06. In some implementations, the radio frequency processing unit 06 may also be referred to as a remote radio unit (RRU), and the baseband processing unit 20 may also be referred to as a baseband unit (BBU).

As shown in FIG. 2, in a possible embodiment, the radio frequency processing unit 06 may be integrated with the antenna 01, the baseband processing unit 20 is located at a remote end of the antenna 01, and the radio frequency processing unit 06 may be connected to the baseband processing unit 20 through the feeder 02. In another embodiment, both the radio frequency processing unit 06 and the baseband processing unit 20 may be located at a remote end of the antenna 01.

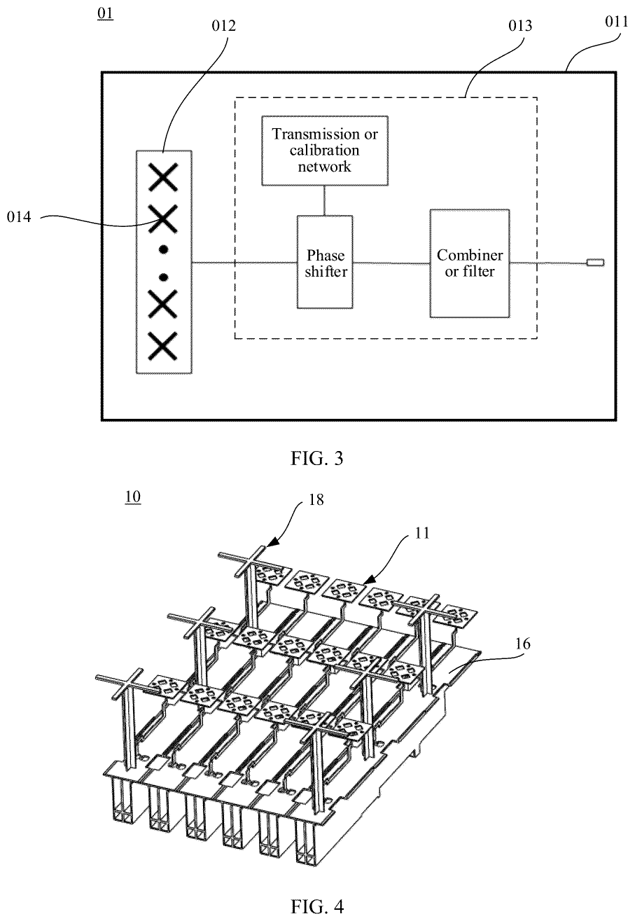

Refer to FIG. 2 and FIG. 3. The antenna 01 used in the base station may further include a radome 011, and a reflective plate 012 and a feeding network 013 that are located in the radome 011. The reflective plate 012 may also be referred to as a bottom plate or a backplane. A main function of the feeding network 013 is to feed a signal to a radiation assembly 014 based on a specific amplitude and phase, or send a radio signal received by the radiation assembly 014 to the baseband processing unit 20 of the base station based on a specific amplitude and phase. It may be understood that, during specific implementation, the feeding network 013 may include at least one of devices: a phase shifter, a combiner, a transmission or calibration network, a filter, or the like. Components and types of the feeding network 013 and functions that can be implemented by the feeding network 013 are not limited in this application.

Certainly, the antenna 01 may be further used in a plurality of other types of communication devices. An application scenario of the antenna 01 is not limited in this application.

For the radome 011, in terms of electrical performance, the radome 011 has good electromagnetic wave penetrability, so that normal sending and receiving of an electromagnetic wave between the radiation assembly 014 and the outside are not affected. In terms of mechanical performance, the radome 011 has good force-bearing performance and antioxidation performance, so that the radome 011 can withstand corrosion of an external harsh environment.

The radiation assembly 014 may also be referred to as a radiation unit, and is a unit that forms a basic structure of the antenna. The radiation assembly 014 can effectively transmit or receive an electromagnetic wave. The radiation assembly 014 may include a plurality of radiation units, and the plurality of radiation units may also form an array for use. During specific application, the radiation unit may be classified into a single-polarization type, a dual-polarization type, and the like. During specific configuration, a type of the radiation unit may be properly selected based on an actual requirement.

In addition, with the continuous development of a mobile communication technology, a 5th generation mobile communication technology (5G) has also been widely applied. As one of the key technologies of the 5G communication system, a massive multiple-input multiple-output (MIMO) technology can effectively improve a channel capacity.

In a background of the massive multiple-input multiple-output technology, a large quantity of radiation assemblies needs to be arranged in the antenna 01. When a distance between the radiation assemblies is small, electromagnetic coupling between two adjacent radiation assemblies is inevitably caused. Electromagnetic coupling between the radiation assemblies not only increases a power loss of the antenna 01, but also causes a bad case such as signal distortion. Therefore, reducing the electromagnetic coupling between the radiation assemblies is crucial to design of a massive array antenna 10.

Therefore, an embodiment of this application provides an antenna that can effectively reduce electromagnetic coupling between radiation assemblies.

To make the objectives, technical solutions, and advantages of this application clearer, the following further describes this application in detail with reference to the accompanying drawings and specific embodiments.

Terms used in the following embodiments are merely intended to describe specific embodiments, but are not intended to limit this application. Terms “one”, “a”, and “this” of singular forms used in this specification and the appended claims of this application are also intended to include a form like “one or more”, unless otherwise specified in the context clearly. It may be further understood that, in the following embodiments of this application, “at least one” means one, two, or more.

Reference to “an embodiment” or the like described in this specification means that one or more embodiments of this application include a particular feature, structure, or characteristic described in combination with the embodiment. Therefore, in this specification, statements, such as “in an embodiment”, “in some embodiments”, and “in other embodiments”, that appear at different places do not necessarily mean referring to a same embodiment, instead, the statements mean referring to “one or more but not all of embodiments”, unless otherwise specifically emphasized in other ways. Terms “include”, “have”, and variants of the terms all mean “include but are not limited to”, unless otherwise specifically emphasized in other ways.

As shown in FIG. 4, in an example provided in this application, an antenna 10 may include a plurality of first radiation assemblies 11 and a plurality of second radiation assemblies 18. An operating frequency of the second radiation assembly 18 is less than an operating frequency of the first radiation assembly 11. During actual use, a radio signal generated by the second radiation assembly 18 generates a sensing signal in the first radiation assembly 11, and secondary radiation generated by the sensor signal interferes with operating performance of the second radiation assembly 18.

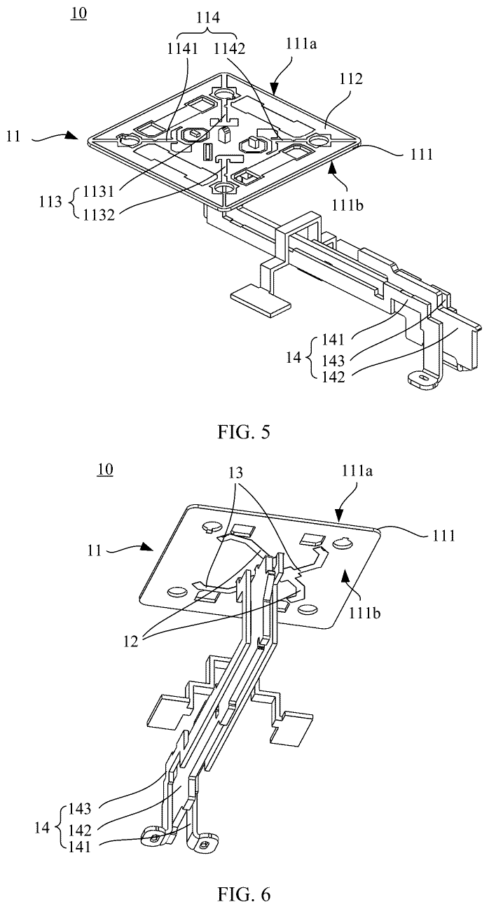

Refer to FIG. 4 and FIG. 5. In an example provided in this application, a length of a feeder assembly 14 of the first radiation assembly 11 may be extended to one-eighth to one-half of an operating wavelength of the second radiation assembly 18, so that a low-frequency common mode current can be effectively suppressed, and a decoupling effect is implemented, to ensure the normal operating performance of the second radiation assembly 18.

In addition, in the antenna 10 provided in this application, the feeder assembly 14 uses a sandwich-like stacking structure. Therefore, it is convenient to flexibly set the length of the feeder assembly 14, and occupied back space of the first radiation assembly 11 is not large. In addition, signal radiation of the feeder assembly 14 can be suppressed by using an open-circuit stub 1421 in a ground cable 142 and a shielding part 15, so that operating performance of the antenna 10 can be ensured.

It may be understood that, during actual application, a structure type of the second radiation assembly 18 may be the same as or similar to a structure type of the first radiation assembly 11. Alternatively, the second radiation assembly 18 may use a currently common structure type. The following uses the first radiation assembly 11 as an example for specific description.

During specific setting, the first radiation assembly 11 may have various structure types.

For example, as shown in FIG. 5 and FIG. 6, in an example provided in this application, the first radiation assembly 11 is a slot antenna. Specifically, the antenna 10 may include the first radiation assembly 11, a first polarization strip 12, a second polarization strip 13, and the feeder assembly 14. The first radiation assembly 11 includes a substrate 111, and the substrate 111 has a first plate surface 111a and a second plate surface 111b that are disposed facing away from each other. As shown in FIG. 5, a conductive layer 112 is disposed on the first plate surface 111a, and the conductive layer 112 is provided with a first polarization radiation slot 113 and a second polarization radiation slot 114. The first polarization radiation slot 113 and the second polarization radiation slot 114 may be excited to generate radio signals; or the first polarization radiation slot 113 and the second polarization radiation slot 114 may effectively receive external radio signals. Specifically, the first polarization radiation slot 113 includes a first slot segment 1131 and a second slot segment 1132 that are separated from each other, and the second polarization radiation slot 114 includes a third slot segment 1141 and a fourth slot segment 1142 that are separated from each other. Refer to FIG. 6. The first polarization strip 12 and the second polarization strip 13 are disposed on the second plate surface 111b and connected to the conductive layer 112, and are configured to excite the first slot segment 1131 and the second slot segment 1132 in the first polarization radiation slot 113. The second polarization strip 13 is configured to excite the third slot segment 1141 and the fourth slot segment 1142 in the second polarization radiation slot 114. The feeder assembly 14 includes a first feeder 141, a ground cable 142, and a second feeder 143. The first feeder 141 is connected to the first polarization strip 12, the second feeder 143 is connected to the second polarization strip 13, and the ground cable 142 is connected to the conductive layer 112.

In an example provided in this application, the antenna 10 may be a dual-polarized antenna. To be specific, the first polarization radiation slot 113 and the second polarization radiation slot 114 are provided orthogonally. The first polarization strip 12 may be simultaneously for exciting the first slot segment 1131 and the second slot segment 1132, so that a balanced feeding function can be implemented. The second polarization strip 13 may be simultaneously for exciting the third slot segment 1141 and the fourth slot segment 1142, so that a balanced feeding function can be implemented. Therefore, the first polarization strip 12 and the second polarization strip 13 may be used as balun structures. In addition, because the first polarization strip 12 and the second polarization strip 13 are integrated on the substrate 111, it is beneficial to implementation of a flat design of the antenna 10. The first feeder 141 is connected to the first polarization strip 12, and a feeding connection to the first slot segment 1131 and the second slot segment 1132 may be implemented through one first feeder 141. This helps reduce a quantity of used feeders. Correspondingly, the second feeder 143 is connected to the second polarization strip 13, and a feeding connection to the third slot segment 1141 and the fourth slot segment 1142 may be implemented through one second feeder 143. This helps reduce a quantity of used feeders. During manufacturing of the substrate 111, the first polarization radiation slot 113, the second polarization radiation slot 114, the first polarization strip 12, and the second polarization strip 13 may also be manufactured. Therefore, convenience during manufacturing is improved.

During specific application, the substrate 111 may be a printed circuit board, or may be a flexible printed circuit board. A material of the conductive layer 112 may include a material with good conductivity, such as copper, silver, or gold. In addition, the first polarization strip 12 and the second polarization strip 13 may be microstrips, striplines, or the like. Specific types of the first polarization strip 12 and the second polarization strip 13 are not limited in this application.

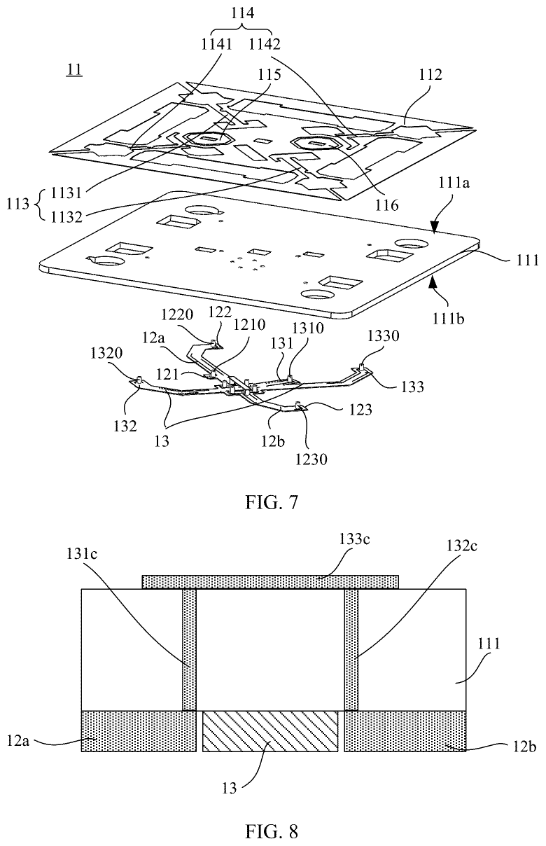

In addition, as shown in FIG. 7 and FIG. 8, during specific disposition, the first polarization strip 12 may have a first connection point 121, a first feed point 122, and a second feed point 123. The first feeder (not shown in the figure) is connected to the first connection point 121, and the first feed point 122 is connected to the conductive layer 112 on one side of the first slot segment 1131, and is configured to excite the first slot segment 1131. The second feed point 123 is connected to the conductive layer 112 on one side of the second slot segment 1132, and is configured to excite the second slot segment 1132. A signal may be separately transmitted from the first connection point 121 of the first polarization strip 12 to the first feed point 122 and the second feed point 123. In other words, the first polarization strip 12 may implement a one-to-two signal transmission function. During specific implementation, a connection distance between the first connection point 121 and the first feed point 122 and a connection distance between the first connection point 121 and the second feed point 123 may be properly set based on an actual requirement, so that balanced feeding can be implemented on the first polarization radiation slot 113. For example, in some cases, the connection distance between the first connection point 121 and the first feed point 122 is equal to the connection distance between the first connection point 121 and the second feed point 123. Alternatively, in some other cases, a difference between the connection distance between the first connection point 121 and the first feed point 122 and the connection distance between the first connection point 121 and the second feed point 123 may be ½×λ. λ is an operating wavelength of the first polarization radiation slot 113. To be specific, λ is a wavelength of a radio signal when the radio signal is propagated in the air, where the radio signal is generated by the first polarization radiation slot 113. It may be understood that, during actual application, a frequency of the radio signal generated by the first polarization radiation slot 113 usually covers a frequency band. Therefore, λ may be a wavelength corresponding to a radio signal at a frequency in the frequency band when the radio signal is propagated in the air.

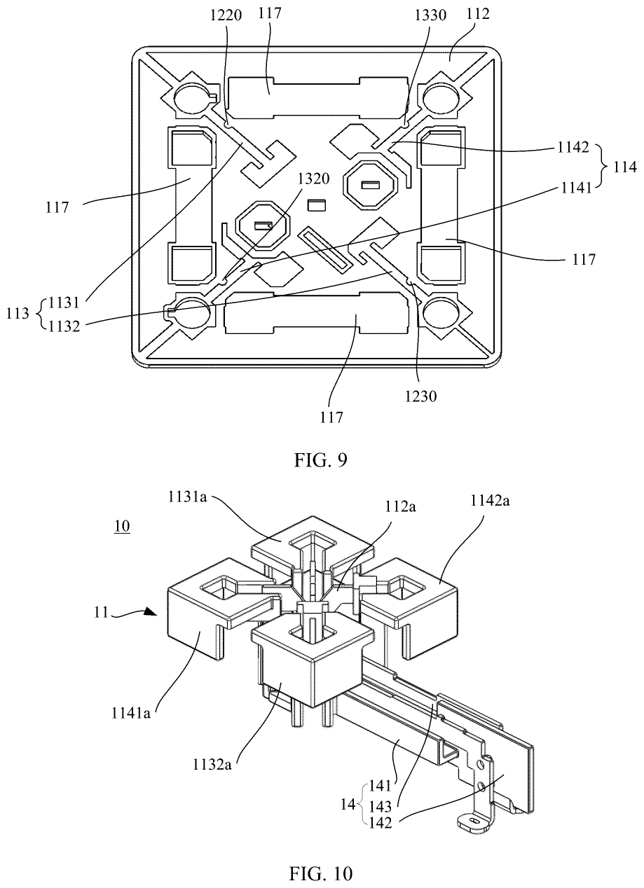

In addition, as shown in FIG. 7 and FIG. 9, in an example provided in this application, the first polarization strip 12 has a stub, and the first connection point 121 is disposed on the stub. During specific application, a length of the stub may be properly set based on an actual requirement. This is not limited in this application. The first feed point 122 and the second feed point 123 are respectively located at two ends of the first polarization strip 12, so that a length of the first polarization strip 12 can be effectively used. It may be understood that, in another example, the stub may be omitted, and the first connection point 121 may be disposed between the first feed point 122 and the second feed point 123 of the first polarization strip 12.

In addition, in an example provided in this application, the first feed point 122 is connected to the conductive layer 112 through a via 1220. Specifically, the via 1220 penetrates through the two plate surfaces of the substrate 111. One end of the via 1220 is connected to the first feed point 122 of the first polarization strip 12, and the other end of the via 1220 is connected to the conductive layer 112.

Correspondingly, the second feed point 123 may be connected to the conductive layer 112 through a via 1230. Specifically, the via 1230 penetrates through the two plate surfaces of the substrate 111. One end of the via 1230 is connected to the second feed point 123 of the first polarization strip 12, and the other end of the via 1230 is connected to the conductive layer 112.

It may be understood that, in another example, a manner such as coupled feeding may alternatively be used between the first polarization strip 12 and the first polarization radiation slot 113. Details are not described herein.

In addition, as shown in FIG. 7 and FIG. 9, in an example provided in this application, a first pad 115 is further disposed on the first plate surface 111a of the substrate 111, and the first connection point 121 is connected to the first pad 115 through a via hole 1210.

In addition, during disposition of the second polarization strip 13, the second polarization strip 13 may be the same as or approximately the same as the first polarization strip 12.

For example, as shown in FIG. 7 and FIG. 9, the second polarization strip 13 may have a second connection point 131, a third feed point 132, and a fourth feed point 133. The second feeder (not shown in the figure) is connected to the second connection point 131, and the third feed point 132 is connected to the conductive layer 112 on one side of the third slot segment 1141, and is configured to excite the third slot segment 1141. The fourth feed point 133 is connected to the conductive layer 112 on one side of the fourth slot segment 1142, and is configured to excite the fourth slot segment 1142. A signal may be separately transmitted from the second connection point 131 of the second polarization strip 13 to the third feed point 132 and the fourth feed point 133. In other words, the second polarization strip 13 may implement a one-to-two signal transmission function. During specific implementation, a connection distance between the second connection point 131 and the third feed point 132 and a connection distance between the second connection point 131 and the fourth feed point 133 may be properly set based on an actual requirement, so that balanced feeding can be implemented on the second polarization radiation slot 114. For example, in some cases, the connection distance between the second connection point 131 and the third feed point 132 is equal to the connection distance between the second connection point 131 and the fourth feed point 133. Alternatively, in some other cases, a difference between the connection distance between the second connection point 131 and the third feed point 132 and the connection distance between the second connection point 131 and the fourth feed point 133 may be ½×λ. λ is an operating wavelength of the second polarization radiation slot 114.

In addition, as shown in FIG. 7 and FIG. 9, in an example provided in this application, the second polarization strip 13 has a stub, and the second connection point 131 is disposed on the stub. During specific application, a length of the stub may be properly set based on an actual requirement. This is not limited in this application. The third feed point 132 and the fourth feed point 133 are respectively located at two ends of the second polarization strip 13, so that a length of the second polarization strip 13 can be effectively used. It may be understood that, in another example, the stub may be omitted, and the second connection point 131 may be disposed between the third feed point 132 and the fourth feed point 133 of the second polarization strip 13.

In addition, in an example provided in this application, the third feed point 132 is connected to the conductive layer 112 through a via 1320. Specifically, the via 1320 penetrates through the two plate surfaces of the substrate 111. One end of the via 1320 is connected to the third feed point 132 of the second polarization strip 13, and the other end of the via 1320 is connected to the conductive layer 112.

Correspondingly, the fourth feed point 133 may be connected to the conductive layer 112 through a via 1330. Specifically, the via 1330 penetrates through the two plate surfaces of the substrate 111. One end of the via 1330 is connected to the fourth feed point 133 of the second polarization strip 13, and the other end of the via 1330 is connected to the conductive layer 112.

It may be understood that, in another example, a manner such as coupled feeding may alternatively be used between the second polarization strip 13 and the second polarization radiation slot 114. Details are not described herein.

In addition, as shown in FIG. 7 and FIG. 9, in an example provided in this application, a second pad 116 is further disposed on the first plate surface 111a of the substrate 111, and the second connection point 131 is connected to the second pad 116 through a via 1310.

In addition, as shown in FIG. 7 and FIG. 8, in an example provided in this application, the first polarization strip 12 and the second polarization strip 13 are in a cross structure. Therefore, in an example provided in this application, the first polarization strip 12 further has a bridge structure 13c. Specifically, the first polarization strip 12 includes a first segment 12a, a second segment 12b, and a bridge structure 12c. The first segment 12a, the second segment 12b, and the second polarization strip 13 are all located on the second plate surface 111b of the substrate 111, and the second polarization strip 13 is located between the first segment 12a and the second segment 12b. The bridge structure 12c includes a via 121c, a via 122c, and a metal strip 123c located on the first plate surface 111a. One end of the via 121c is connected to the first segment 12a, and the other end of the via 121c is connected to the metal strip 123c. One end of the via 122c is connected to the second segment 12b, and the other end of the via 122c is connected to the metal strip 123c. After a signal is transmitted from the first connection point 121 to the first polarization strip 12, the signal may be transmitted to the second feed point 123 by using the bridge structure 12c including the via hole 121c, the metal strip 123c, and the via hole 122c.

It may be understood that, in another example, another type of bridge structure may alternatively be used in the first polarization strip 12. Alternatively, a bridge structure may be used in the second polarization strip 13, and details are not described herein.

In addition, as shown in FIG. 9, in an example provided in this application, the conductive layer 112 is further provided with a plurality of isolation grooves 117, and the plurality of isolation grooves 117 are provided along an edge of the conductive layer 112, so that isolation between the first polarization radiation slot 113 and the second polarization radiation slot 114 can be effectively improved. Specifically, in an example provided in this application, the isolation groove 117 is dumbbell-shaped, and four isolation grooves are provided. The isolation grooves 117 each are provided between adjacent slot segments.

In addition, during specific setting, a length of the isolation groove 117 may be ¼×λ, so that a great isolation effect can be achieved. λ is an operating wavelength of the first radiation assembly 11. In an example provided in this application, the first radiation assembly 11 is of a dual-polarization type, and operating frequencies of the first polarization radiation slot 113 and the second polarization radiation slot 114 are almost the same. Therefore, operating frequencies of the first radiation assembly 11, the first polarization radiation slot 113, and the second polarization radiation slot 114 are almost the same. λ may also be understood as the operating wavelength of the first polarization radiation slot 113 or the operating wavelength of the second polarization radiation slot 114.

It may be understood that, in another example, a shape of the isolation groove 117, a size of the isolation groove 117, and a quantity of isolation grooves 117 may be properly set based on actual requirements. This is not limited in this application.

In addition, as shown in FIG. 10, in another example provided in this application, a first radiation assembly 11 may alternatively implement wireless communication by using a radiation arm. Specifically, the first radiation assembly 11 may include a first radiation arm 1131a, a second radiation arm 1132a, a third radiation arm 1141a, and a fourth radiation arm 1142a. A first feeder 141 may be in feeding connection to the first radiation arm 1131a and the second radiation arm 1132a, a second feeder 143 may be in feeding connection to the third radiation arm 1141a and the fourth radiation arm 1142a, and a ground cable 142 is connected to a conductor 112a.

Alternatively, it may be understood that, during actual application, a structure type of the first radiation assembly 11 may be flexibly configured based on an actual requirement, and a feeder assembly 14 may be well adapted to a plurality of different types of first radiation assemblies 11.

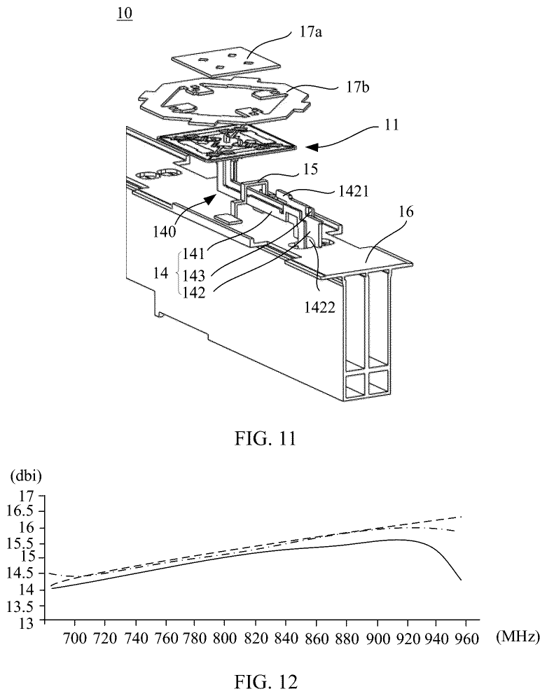

For the feeder assembly 14, as shown in FIG. 11, in an example provided in this application, the feeder assembly 14 is of a sandwich-shaped structure. Specifically, the first feeder 141, the ground cable 142, and the second feeder 143 are stacked sequentially, so that a flat design of the feeder assembly 14 can be implemented. A transmission line for transmitting a signal may include the first feeder 141 and the ground cable 142, and another transmission line for transmitting a signal may include the second feeder 143 and the ground cable 142. As a common ground of the first feeder 141 and the second feeder 143, the ground cable 142 may provide a good isolation effect on the first feeder 141 and the second feeder 142, so that efficient transmission of a signal is ensured. During specific implementation, the feeder assembly 14 may be disposed in a circuit board (for example, a printed circuit board or a flexible printed circuit board), and the first feeder 141, the ground cable 142, and the second feeder 143 may be located at different layers in the circuit board. This can effectively improve convenience of manufacturing the feeder assembly 14.

In addition, as shown in FIG. 11, the ground cable 142 has an open-circuit stub 1421, a length of the open-circuit stub 1421 is one-quarter of an operating wavelength of the first radiation assembly 11, and the open-circuit stub may be configured to suppress radiation of the ground cable 142. For example, during actual application, the feeder assembly 14 may need to be set to be long. As a result, the ground cable 142 may radiate a radio signal, and a directivity pattern characteristic of the first radiation assembly 11 may be deteriorated. In the example provided in this application, the open-circuit stub is disposed in the ground cable 142, so that the radio signal radiated by the ground cable 142 can be effectively suppressed, thereby effectively ensuring directivity pattern performance of the first radiation assembly 11.

In addition, as shown in FIG. 11, in an example provided in this application, the feeder assembly 14 is generally of an L-shaped structure, and is located between a backplane 16 and the first radiation assembly 11. In other words, the feeder assembly 14 has a corner 140. In this structure, back space of the first radiation assembly 11 occupied by the feeder assembly 14 can be effectively reduced. For example, when the feeder assembly 14 is in a straight line-shape, back space greater than or equal to a length of the feeder assembly 14 needs to be reserved on the back of the first radiation assembly 11. If the feeder assembly 14 is bent, the back space can be effectively reduced.

During actual use, current radiation may be generated at the corner 140 of the feeder assembly 14, and consequently, operating performance of the first radiation assembly 11 is affected.

Therefore, as shown in FIG. 11, in an example provided in this application, the antenna 10 may further include a shielding part 15, and the shielding part 15 is disposed close to the corner 140 and is grounded.

Specifically, the shielding part 15 may be U-shaped, and is sleeved on a periphery of the feeder assembly 14, and two ends of the shielding part 15 are grounded.

During specific disposition, the shielding part 15 may be short-circuited to the ground, or may be coupled to the ground. Specifically, during short-circuit grounding, the two ends of the shielding part 15 may be directly conductively connected to the backplane 16. During coupling grounding, a small gap may be kept between each of the two ends of the shielding part 15 and the backplane. In addition, in another example, the shielding part 15 may alternatively be in another structural shape such as an arc shape. During specific implementation, a grounding manner, a shape, and the like of the shielding part 15 may be properly set based on actual requirements. Details are not described herein.

In addition, as shown in FIG. 11, in an example provided in this application, an avoidance groove 1422 is provided at one end that is of the ground cable 142 and that is away from the first radiation assembly 11, and projections of the first feeder 141 and the second feeder 143 on the ground cable 142 are located in the avoidance groove 1422. Specifically, during actual application, the feeder assembly 14 may be soldered to the backplane 16, and a pad configured to be soldered to the first feeder 141 and the second feeder 143 may be disposed in the backplane. The feeder assembly 14 is of the sandwich-shaped structure. Therefore, the ground cable 142 is close to the first feeder 141 and the second feeder 143. To prevent the ground cable 142 from blocking the pad, the avoidance groove 1422 is provided at an end that is of the ground cable 142 and that is connected to the backplane.

In addition, as shown in FIG. 11, in an example provided in this application, the antenna 10 may further include a director 17a and a director 17b. The director 17a and the director 17b may be disposed on a side that the first plate surface 111a faces (or on a radiation side of the first radiation assembly 11), to expand an operating bandwidth of the first radiation assembly 11.

During specific setting, the director may have various structure types. For example, in an example provided in this application, the director 17a is approximately a square plate, and the director 17a operates at a relatively low frequency band of the first radiation assembly 11. The director 17b is approximately an octagonal plate, and the director 17b operates at a relatively high frequency band of the first radiation assembly 11. During specific setting, a side length of the director 17a may be 0.5 wavelength of a radio signal at the relatively low frequency band of the first radiation assembly 11 when the radio signal is propagated in the air. An equivalent diameter of the director 17b may be 0.5 wavelength of a radio signal at a relatively low frequency band and a relatively high frequency band of the first radiation assembly 11 when the radio signal is propagated in the air. An equivalent diameter of the director 17b is a diameter of a circular area in which the director is located.

It may be understood that, during specific setting, parameters such as a quantity of directors, a size of the director, and a shape of the director may be properly selected based on actual situations. This is not limited in this application.

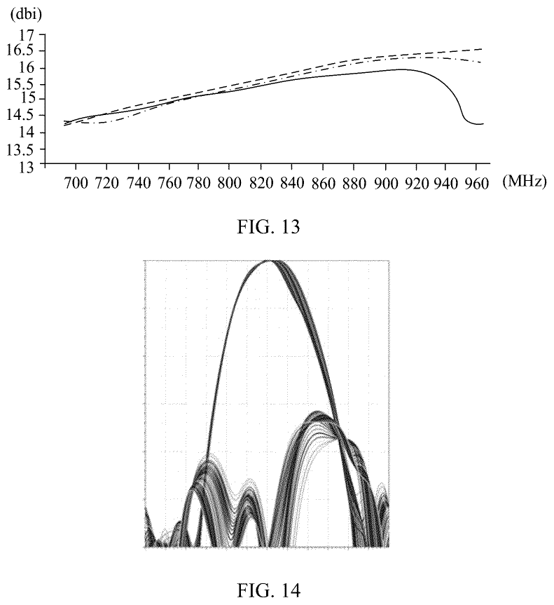

In addition, as shown in FIG. 12 and FIG. 13, embodiments of this application further provide data diagrams in which a radiation gain of the second radiation assembly 18 varies with a frequency in different cases. The second radiation assembly 18 is of a dual-polarization type. FIG. 12 shows a data diagram in which a radiation gain varies with a frequency in a polarization direction of the second radiation assembly 18. FIG. 13 is a data diagram in which a radiation gain varies with a frequency in another polarization direction of the second radiation assembly 18.

In FIG. 12 and FIG. 13, a horizontal coordinate represents a frequency in a unit of MHz, and a vertical coordinate represents a radiation gain in a unit of dbi. In addition, a dashed line represents a data curve in which a radiation gain of the separate second radiation assembly 18 varies with a frequency. A solid line represents a data curve in which a radiation gain of the second radiation assembly 18 varies with a frequency after a conventional first radiation assembly is disposed. A dash-dotted line represents a data curve in which a radiation gain of the second radiation assembly 18 varies with a frequency after the first radiation assembly 11 provided in embodiments of this application is disposed. To be specific, the length of the feeder assembly 14 of the first radiation assembly 11 is extended to one-eighth to one-half of the operating wavelength of the second radiation assembly 18.

It may be found through comparison that, after the conventional first radiation assembly is disposed near the second radiation assembly 18, the radiation gain of the second radiation assembly 18 is evidently reduced. After the length of the feeder assembly 14 of the first radiation assembly is extended to one-eighth to one-half of the operating wavelength of the first radiation assembly 18, an impact of the first radiation assembly 11 on the second radiation assembly 18 can be significantly reduced, so that the second radiation assembly 18 has a good radiation gain.

In addition, as shown in FIG. 14 to FIG. 16, embodiments of this application further provide directivity patterns of the second radiation assembly 18 in different cases.

FIG. 14 shows a directivity pattern of the separate second radiation assembly 18. It may be learned that a shape of the directivity pattern is relatively convergent and smooth.

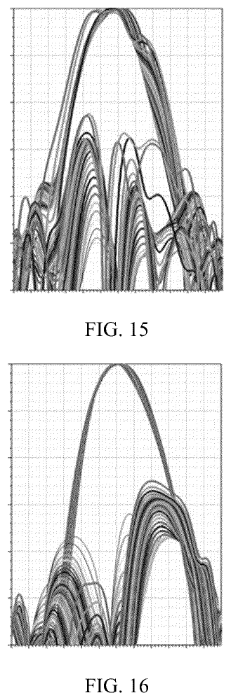

FIG. 15 shows a directivity pattern of the second radiation assembly 18 after a conventional first radiation assembly is disposed near the second radiation assembly 18. It may be learned that a shape of the directivity pattern is evidently distorted.

FIG. 16 shows a directivity pattern of the second radiation assembly 18 after the first radiation assembly 11 provided in embodiments of this application is disposed near the second radiation assembly 18. It may be learned that, in this case, a shape of the directivity pattern is relatively convergent and smooth, and is relatively similar to the shape of the directivity pattern in FIG. 14.

During application, a more convergent and smoother shape of the directivity pattern of the second radiation assembly 18 represents better operating performance of the second radiation assembly 18. Therefore, the first radiation assembly 11 provided in embodiments of this application can be used to effectively ensure the operating performance of the second radiation assembly 18.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a first radiation assembly;
a second radiation assembly, wherein an operating frequency of the second radiation assembly is less than an operating frequency of the first radiation assembly; and
a feeder assembly, in feeding connection to the first radiation assembly, wherein the feeder assembly comprises a first feeder, a ground cable, and a second feeder that are stacked sequentially, and the feeder assembly has a length ranging from one-eighth to one-half of an operating wavelength of the second radiation assembly.

2. The antenna according to claim 1, wherein the ground cable has an open-circuit stub, and a length of the open-circuit stub is one-quarter of an operating wavelength of the first radiation assembly.

3. The antenna according to claim 1, further comprising a shielding part, wherein
the feeder assembly has a corner, and the shielding part is disposed in proximity to the corner.

4. The antenna according to claim 3, wherein the shielding part is U-shaped, the shielding part is sleeved on a periphery of the feeder assembly, and two ends of the shielding part are grounded.

5. The antenna according to claim 1, further comprising a backplane, wherein one end of the feeder assembly that is away from the first radiation assembly is connected to the backplane.

6. The antenna according to claim 5, wherein an avoidance groove is provided at one end that is of the ground cable that is away from the first radiation assembly, and projections of the first feeder and the second feeder on the ground cable are located in the avoidance groove.

7. The antenna according to claim 1, wherein the first radiation assembly comprises a substrate, a first polarization strip, and a second polarization strip;
the substrate has a first plate surface and a second plate surface that are disposed facing away from each other;
a conductive layer is disposed on the first plate surface, and the conductive layer is provided with a first polarization radiation slot and a second polarization radiation slot;
the first polarization radiation slot comprises a first slot segment and a second slot segment, and the second polarization radiation slot comprises a third slot segment and a fourth slot segment;
the first polarization strip is disposed on the second plate surface, and the first polarization strip is configured to excite the first slot segment and the second slot segment in the first polarization radiation slot;
the second polarization strip is disposed on the second plate surface, and the second polarization strip is configured to excite the third slot segment and the fourth slot segment in the second polarization radiation slot; and
the first feeder is connected to the first polarization strip, the second feeder is connected to the second polarization strip, and the ground cable is connected to the conductive layer.

8. The antenna according to claim 7, wherein the first polarization strip has a first connection point, a first feed point, and a second feed point;
the first feeder is connected to the first connection point, the first feed point is configured to excite the first slot segment, and the second feed point is configured to excite the second slot segment; and
a connection distance between the first connection point and the first feed point is equal to a connection distance between the first connection point and the second feed point.

9. The antenna according to claim 8, wherein a first pad is disposed on the first plate surface, and one end of the first feeder is soldered to the first pad; and
the antenna is provided with a first via that penetrates through the first plate surface and the second plate surface, and the first pad is connected to the first connection point through the first via.

10. The antenna according to claim 7, wherein the second polarization strip has a second connection point, a third feed point, and a fourth feed point;
the second feeder is connected to the second connection point, the third feed point is configured to excite the third slot segment, and the fourth feed point is configured to excite the fourth slot segment; and
a connection distance between the second connection point and the third feed point is equal to a connection distance between the second connection point and the fourth feed point.

11. The antenna according to claim 10, wherein a second pad is disposed on the first plate surface, and one end of the second feeder is soldered to the second pad; and
the antenna is provided with a second via that penetrates through the first plate surface and the second plate surface, and the second pad is connected to the second connection point through the second via.

12. The antenna according to claim 7, wherein the conductive layer is further provided with a plurality of isolation grooves, and the plurality of isolation groove are provided along an edge of the conductive layer.

13. The antenna according to claim 12, wherein a length of an isolation groove of the plurality of isolation grooves is one-quarter of the operating wavelength of the first radiation assembly.

14. The antenna according to claim 7, wherein the first polarization radiation slot and the second polarization radiation slot are provided orthogonally.

15. The antenna according to claim 1, further comprising at least one director, wherein the at least one director is disposed in a radiation direction of the first radiation assembly.

16. A communication device, comprising a controller and an antenna, wherein the controller is connected to a feeder assembly of the antenna, wherein the antenna comprises:
a first radiation assembly;
a second radiation assembly, wherein an operating frequency of the second radiation assembly is less than an operating frequency of the first radiation assembly; and
the feeder assembly, in feeding connection to the first radiation assembly, wherein the feeder assembly comprises a first feeder, a ground cable, and a second feeder that are stacked sequentially, and the feeder assembly has a length ranging from one-eighth to one-half of an operating wavelength of the second radiation assembly.

17. The communication device according to claim 16, wherein the ground cable has an open-circuit stub, and a length of the open-circuit stub is one-quarter of an operating wavelength of the first radiation assembly.

18. The communication device according to claim 16, further comprising a shielding part, wherein
the feeder assembly has a corner, and the shielding part is disposed in proximity to the corner.

19. The communication device according to claim 18, wherein the shielding part is U-shaped, the shielding part is sleeved on a periphery of the feeder assembly, and two ends of the shielding part are grounded.

20. The communication device according to claim 16, further comprising a backplane, wherein one end of the feeder assembly that is away from the first radiation assembly is connected to the backplane.
